(19) United States
(12) Patent Application Publication
(10) Pub. No.: US 2024/0184330 A1
(43) Pub. Date: Jun. 6, 2024

(54) Devices With Adjustable Headbands

(71) Applicant: Apple Inc., Cupertino, CA (US)

(72) Inventors: Aiden D Mossop, San Francisco, CA (US); Jenna L Withrow, Sunnyvale, CA (US); Ryan M David, San Francisco, CA (US); Zebinah P Masse, Los Altos, CA (US); Christopher Sa Glaister, Oakland, CA (US); Heidi Williamson, Los Altos, CA (US); Timon A Wright, San Francisco, CA (US); Evan A Cernokus, Campbell, CA (US)

(21) Appl. No.: 18/441,629

(22) Filed: Feb. 14, 2024

Related U.S. Application Data
(63) Continuation of application No. PCT/US22/41577, filed on Aug. 25, 2022.
(60) Provisional application No. 63/241,235, filed on Sep. 7, 2021.

(51) Int. Cl. G06F 1/16

(52) U.S. Cl. CPC G06F 1/163

(57) ABSTRACT

A head-mounted device may have a head-mounted housing containing rear-facing displays that display images for a user when the head-mounted housing is worn by the user. The head-mounted device may have an adjustable-tension headband coupled between first and second sides of the head-mounted housing. The adjustable-tension headband may be operable in a stretch fabric tensioned mode in which tension for the headband is provided by stretching a length of stretchable fabric in the headband and may be operable in a cable-tensioned mode in which tension for the headband is applied by a tensioned cable. A knob or other adjustable cable tensioning mechanism may be used to adjust cable tension.

This application is a continuation of international patent application No. PCT/US2022/041577, filed Aug. 25, 2022, which claims priority to U.S. provisional patent application No. 63/241,235, filed Sep. 7, 2021, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have a head-mounted housing and an associated adjustable-tension headband. The adjustable-tension headband may have first and second ends coupled to first and second opposing sides of the head-mounted housing.

The headband may create headband pressure using a stretchable material and using a tensioned cable. The stretchable material may be formed from a knit fabric or other material that creates headband tension when stretched. The fabric may have a channel that receives a loop of cable. A knob or other adjustable cable tensioning mechanism may be used to adjust tension in the cable and thereby apply an adjustable amount of cable tension to the headband.

### BRIEF DESCRIPTION OF THE DRAWINGS

FIG. 1 is a side view of an illustrative electronic device such as a head-mounted display device with an adjustable headband in accordance with an embodiment.

FIG. 2 is a plan view of an illustrative adjustable headband in accordance with an embodiment.

FIG. 3 is a cross-sectional side view of an end portion of a headband in accordance with an embodiment.

FIG. 4 is a cross-sectional perspective view of an illustrative stretchy fabric headband with a headband tensioning cable embedded in an interior cable channel in accordance with an embodiment.

FIG. 5 is a top view of an illustrative pulley for an adjustable cable-tensioned head-mounted device headband in accordance with an embodiment.

FIG. 6 is a perspective view of the illustrative pulley of FIG. 5 in accordance with an embodiment.

FIG. 7 is a graph illustrating operations associated with use of a head-mounted device with an adjustable headband in accordance with an embodiment.

### DETAILED DESCRIPTION

Head-mounted devices include head-mounted support structures that allow the devices to be worn on the heads of users. The head-mounted support structures, which may sometimes be referred to as a head-mounted support, may include device housings for housing components such as displays that are used for presenting a user with visual content. The head-mounted support structures for a head-mounted device may also include headbands and other structures that help hold a device housing on the face of a user. The headband of a head-mounted device may be adjustable.

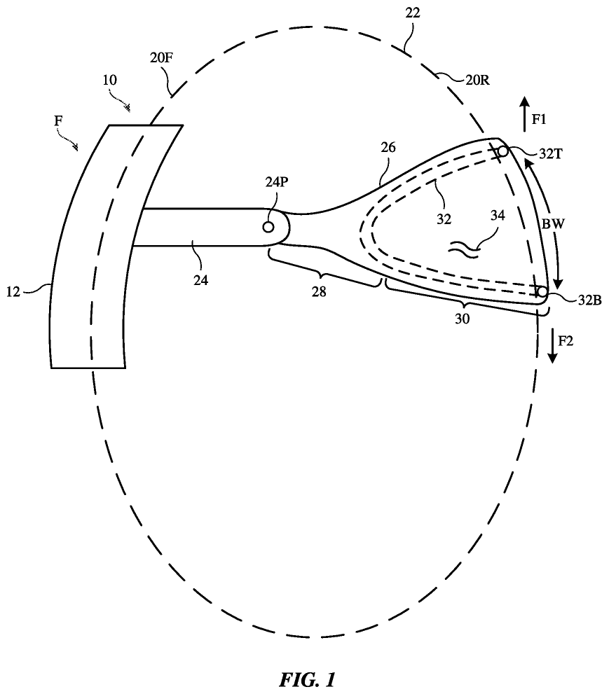

FIG. 1 is a side view of an illustrative head-mounted electronic device with an adjustable headband. As shown in FIG. 1, head-mounted device 10 may include head-mounted housing 12 (sometimes referred to as a main housing, main housing unit, head-mounted support structure, etc.). Housing 12 may have walls or other structures that separate an interior housing region from an exterior region surrounding housing 12. For example, housing 12 may have walls formed from polymer, glass, metal, and/or other materials. Electrical and optical components may be mounted in housing 12. These components may include components such as integrated circuits, sensors, control circuitry, input-output devices, etc.

To present a user with images for viewing from eye boxes (e.g., eye boxes in which the user's eyes are located when device 10 is being worn on the users' head such as head 22 of FIG. 1), device 10 may include displays and lenses. These components may be mounted in optical modules or other supporting structure in housing 12 to form respective left and right optical systems. There may be, for example, a left display for presenting an image through a left lens to a user's left eye in a left eye box and a right display for presenting an image to a user's right eye in a right eye box.

If desired, housing 12 may have forward-facing components such as cameras and other sensors on front F for gathering sensor measurements and other input and may have a soft cushion on an opposing rear side of housing 12. The rear of housing 12 may have openings that allow the user to view images from the left and right optical systems (e.g., when the rear of housing 12 is resting on front surface 20F of the user's head 22.

Device 10 may have an adjustable strap such as adjustable headband 26 and, if desired, may have other structures (e.g., an optional over-the-head strap) to help hold housing 12 on head 22. Headband 26 may have first and second ends coupled, respectively, to the left and right sides of housing 12. In the example of FIG. 1, coupling members 24, which serve as extensions of housing 12, are provided on the left and right sides of housing 12. Members 24 may be formed from rigid materials such as rigid polymer and/or other materials and may contain sensors, buttons, speakers, and other electrical components. Hinges and/or other mechanisms may be used to couple members 24 to housing 12 or members 24 may be formed as integral portions of a main housing unit. The ends of headband 26 may have coupling mechanisms such as openings configured to receive posts or other protrusions 24P on members 24 or other housing structures. These coupling mechanisms allow a user to removably attach headband 26 to members 24 and thereby removable attach headband 26 to housing 12. Members 24 may have elongated shapes of the type shown in FIG. 1 and/or other suitable shapes and may sometimes be referred to as rigid straps, rigid coupling members, or power straps.

Strap 26 may have a soft flexible portion such as central portion 30. Portion 30 may be formed between two stiffer portions such as end portions 28 on the left and right ends of headband 26. Portions 28 may be stiffened using embedded polymer stiffeners (e.g., single-layer or multilayer polymer stiffening strips) and/or other stiffening members.

Portion 30 may be formed from a stretchable material such as stretchy fabric. Portion 30 may, as an example, be formed from a band of flat knit fabric that includes stretchable strands 34 of material (e.g., elastomeric strands) and/or which uses a stretchable fabric construction (e.g., a stretchable knit construction). Narrowed end portions of the band of knit fabric may, if desired, extend over stiffening members in end portions 28 (e.g., to ensure that headband 26 has a uniform external appearance).

The stretchability of headband portion 30 (and therefore headband 26) allows headband 26 be stretched along its length. This allows the length of headband 26 to be temporarily increased to help a user place headband 26 over the user's head when a user is donning device 10. When headband 26 is released, the stretchiness and elastic nature of portion 30 of headband 26 will help shorten headband 26 and pull headband 26 against the user's head so that headband 26 rests against rear surface 20R the user's head. Further adjustment of the tension of headband 26 to secure headband 26 and device 10 on the user's head may be provided using a tensioning mechanism that adjusts headband tensioning cable 32. The adjustable cable tensioning mechanism may be a rotatable knob, lever, slider, or other mechanism for adjusting tension in cable 32. When cable tension is low, headband 26 will be loose. The low cable tension of the cables helps to create slack in headband 26 to accommodate donning and doffing of device 10. When cable tension is increased, headband 26 is secured against the user's head.

As shown in FIG. 1, cable 32 may have a loop shape with an upper segment that runs along the upper edge of headband 26 (see, e.g., upper cable segment 32T) and an opposing lower segment that runs along the opposing lower edge of headband 26 (see, e.g., lower cable segment 32B). In the middle of central portion 30 of headband 26, upper and lower segments 32T and 32B may be separated by a distance BW (sometimes referred to as a cable bifurcation distance) of at least 2 cm, at least 5 cm, at least 10 cm, at least 20 cm, less than 25 cm, less than 15 cm, or other suitable distance (as examples). The separation between segments 32T and 32B helps secure headband 26 on curved rear surface 20R of head 22. When headband 26 is being worn on rear surface 20R as shown in FIG. 1, upper cable segment 32T may help apply an upward force F1 on headband 26 that may help prevent headband 26 from slipping downwards off of head 22, whereas lower cable segment 32B may help apply a downward force F2 that may help prevent headband 26 from slipping upwards off of head 22.

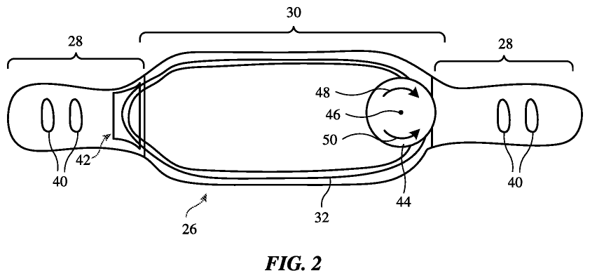

FIG. 2 is a plan view of headband 26 in a configuration in which headband 26 is not attached to housing 12. As shown in FIG. 2, headband 26 may have a stretchable central portion 30 formed from stretchy knit fabric and may have left and right ends 28 (e.g., end portions that are stiffened using stiffeners embedded in the fabric). One or more openings 40 may be formed in the ends of headband 26. Openings 40 may receive posts or other protrusions such as protrusion 24P of FIG. 1 to secure the left and right ends of headband 26 to the left and right members 24 of device 10. There may be a single opening 40 or other attachment mechanism located on each end of headband 26 or each end of headband 26 may have two or more openings 40. If desired, other attachment mechanism (e.g., magnets, snaps, hook-and-loop fasteners, screws or other fasteners, etc.) may be used in attaching headband 26 to members 24 or other portions of the housing of device 10.

Cable 32 may extend in a loop around the perimeter of portion 30 of headband 26. At the left side of headband 26 of FIG. 2, headband 26 includes pulley 42, which is coupled to left end portion 28. At the right side of headband 26, headband 26 includes an adjustable cable tensioning mechanism such as cable tension adjustment knob (dial) 44, which is coupled to end portion 28. Knob 44 may be a two-way knob that can be rotated in a first direction about rotational axis 46 (e.g., clockwise direction 48) to shorten the length of the loop of cable 32 and thereby increase tension on cable 32 and that can be rotated in an opposing second direction about rotational axis 46 (e.g., counterclockwise direction 50) to increase the length of the loop of cable 32 and thereby decrease tension on cable 32. By tightening cable 32, tension in headband 26 can be increased and device 10 can be held more snugly on the user's head. The presence of pulley 42 allows tension in the upper and lower portions of cable 32 to be balanced, thereby helping to ensure a consistent cupping of the band across various head shapes. By loosening cable 32, tension in headband 26 can be decreased.

If desired, knob 44 may be configured so that when sufficient force is applied to headband 26 (e.g., when a user pulls device 10 outwardly away from headband 26) and/or when a user activates a cable release latch or other cable tension release mechanism, knob 44 will freewheel and thereby allow the loop of cable 32 to be lengthened (e.g., cable 32 can be allowed to spool outwardly from knob 44 to permit device 10 to be taken off). Knob 44 may also have a retention spring that takes up slack in cable 32 when device 10 is rested on a table top or other surface (e.g., when device 10 is not being worn). Knob 44 may use cam mechanisms, springs or other biasing mechanisms, and/or other mechanisms to implement these features and/or other suitable cable tensioning mechanisms (sliders, levers, etc.) may be used to control the tension of cable 32.

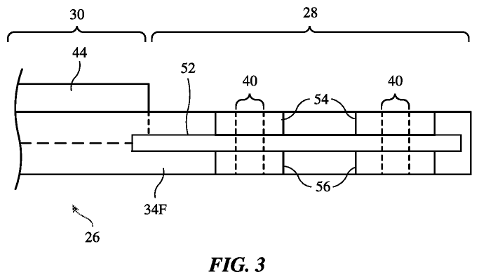

FIG. 3 is a cross-sectional side view of an illustrative end portion (e.g., a right-hand end portion) of headband 26. As shown in FIG. 3, headband 26 may be formed from fabric 34F. Fabric 34F may be formed from strands 34 that are intertwined using knitting, weaving, braiding, and/or other strand intertwining techniques. In an illustrative configuration, fabric 34F is formed as a single piece using a flat knitting technique and includes a built-in channel (sometimes referred to as a pocket). Stiffener 52 may be formed from a flexible strip of polymer (e.g., an elastomer such as thermoplastic polyurethane) that has been inserted into the channel in fabric 34F. Stiffener 52 is sufficiently flexible to permit portions 28 to bend and twist, but does not stretch substantially along its length and may therefore sometimes be referred to as a non-stretchable stiffener, non-stretchable member, non-stretchable stiffening structure, etc. Stiffener 52 is significantly less stretchy and soft than fabric 34F and serves to increase the stiffness and decrease (or eliminate) stretchiness of end portion 28 relative to center portion 30. At the same time, the flexibility of stiffener 52 allows end portions 28 of headband 26 to bend around the curvature of a user's head.

Openings 40 may be formed through fabric 34F and through stiffener 52. Adhesive layers may be used to mount stiffener 52 within the channel in fabric 34F. Openings 40 may be reinforced using metal rings (e.g., stainless steel rings) that surround each opening. Ring-shaped caps 54 may be placed on one side of portion 28 and mating ring-shapes sockets 56 may be placed on an opposing side of portion 28. The openings in these structures may be aligned with openings 40. Caps 54 and sockets 56 may have inwardly protruding portions that interlock with each other. When joined, the mating sockets and caps create a reinforced ring-shaped border for each opening 40. Cosmetic covering layers (e.g., ring-shaped polyurethane sheets and/or other cosmetic covers) may be placed over the exterior surface of the sockets and caps to help enhance the appearance of headband 26. Adhesive rings may be used to hold the ring-shaped cosmetic covers, sockets, and caps, in place.

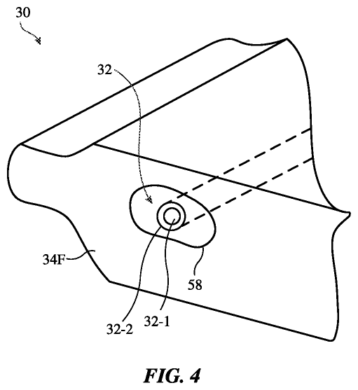

FIG. 4 is a cross-sectional perspective view of an edge portion of stretchable portion 30 of headband 26. As shown in FIG. 4, fabric 34F may be knit to form an embedded cable channel such as channel 58 that receives cable 32. Cable channel 58 may have an oval shape, a circular shape, or other cross-sectional shape. Cable 32 may be a monofilament strand or may be a multifilament strand formed from multiple monofilament strands. The strands that make up cable 32 may be polymer strands and/or strands of other materials. In an illustrative configuration, strand 32 has a multifilament core 32-2 formed from multiple strands surrounded by a braided sheath 32-1 formed from braided strands. The polymer strands of core 32-2 may be polyaromatic amide strands, polyester strands, or other polymer strands. The use of multiple strands in core 32-2 may help enhance the tensile strength of cable 32. Sheath 32-1 may be formed from braided nylon strands (as an example). The presence of sheath 32-1 on cable 32 (e.g., the use of a sheathed cable in headband 26) may help enhance flexibly and reduce friction between cable 32 and the inner walls of cable channel 58. To ensure that tension is applied satisfactorily by cable 32 to headband 26, cable 32 is preferably a non-stretchable cable. During operation, headband 26 is partly held on the head of the user due to tension from the stretched knit fabric of headband 26 and is partly held on the head of the user by the additional tension applied by the adjustable-tension cable. To allow the tension of the headband to be controlled when cable 32 is tightened, cable 32 is preferably significantly stiffer than the stretchable fabric (e.g., the longitudinal stiffness of cable 32, which is taken along its length, is greater than the associated longitudinal stiffness of the stretchable fabric of headband 26). This relationship of relative stiffnesses between the cable and fabric of headband 26 helps make headband 26 easy to don and doff while supporting stable operation at a low total tension when cable 32 is tightened.

As shown in FIG. 2, cable 32 runs in a loop between knob 44 at one end of headband 26 and pulley 42 at an opposing end of headband 26. Cable 32 can slide freely within pulley 42 so that tension on the upper and lower segments of cable 32 can be equalized. This helps balance tension in the upper and lower segments to ensure a consistent cupping of headband 26 across various head shapes. Pulley 42 may be formed from a portion of stiffener 52 in a given end portion 28 (e.g., the left-hand end portion 28) and/or may be attached to stiffener 52. This allows tension from cable 32 to be transferred to that given end portion 28.

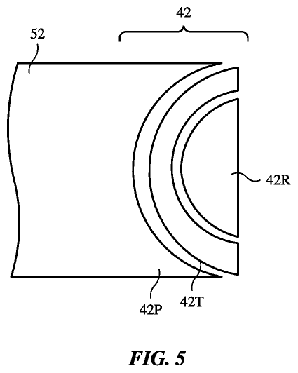

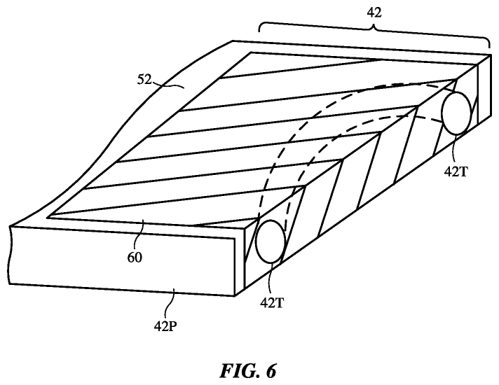

A top view of an illustrative pulley is shown in FIG. 5. As shown in FIG. 5, pulley 42 may include pulley tube 42T (e.g., a tube formed from a low-friction polymer such as polytetrafluorethylene) captured between a tube retention member such as half-moon spacer 42R and portion 42P of stiffener 52 (or a separate polymer member that is attached to stiffener 52). Portion 42P and spacer 42R may be formed from a polymer such as thermoplastic polyurethane. A fabric retention layer (e.g., a strip of fabric attached by adhesive) may be wrapped around the end of pulley 42 to help hold half-moon spacer 42R and tube 42T in place, as shown by wrapped fabric strip 60 of FIG. 6. Fabric strip 60 may be a woven fabric formed from liquid-crystal polyester strands or other strong polymer strands.

With headband 26 of FIGS. 1 and 2, headband tension can be applied in two ways. First, when portion 30 is stretched, the resulting inwardly directed (length shortening) restoring force generated by stretched portion 30 will create a first amount of tension. In an illustrative configuration, this first amount of tension is sufficient to hold device 10 and headband 26 in place on head 22 without slipping, but is not typically sufficient to hold device 10 in place when a user is moving significantly (e.g., during a video game or other active use). To help hold device 10 in place satisfactorily for game play and other active use scenarios, cable 32 may be tensioned to a desired higher level using knob 44 or other adjustable cable tensioning mechanism. The cable tensioning mechanism shortens cable 32 and thereby places portion 30 (and therefore headband 26) in tension. Because tension is applied in two ways (a first of which results from the contraction of stretched fabric portion 30 independent of the state of cable 32 and second of which results from the tightening of cable 32 independent of the stretch state of fabric portion 30), headband 26 may sometimes be referred to as using a hybrid tensioning arrangement.

Because headband 26 uses a hybrid tensioning arrangement, headband 26 can be operate in two modes. During a first mode, knob 44 spins freely or otherwise is configured to allow cable 32 to lengthen and shorten without applying significant tension to headband 26. In this first mode, which may sometimes be referred to as a stretch fabric tensioned mode, tension is applied only from the stretched fabric of portion 30. The knit strands of portion 30 can stretch and relax unhindered by cable 32, so that headband 26 acts as a soft natural stretchable fabric headband and does not require knob manipulation.

During a second mode, cable 32 may be tensioned using knob 44. This allows a higher level of tension can be applied to headband 26, as appropriate when preparing device 10 for use in playing a video game or other activity in which a user may move head 22 vigorously. During this second mode, which may sometimes be referred to as a cable-tensioned mode, headband tension is mostly provided by the tightening of cable 32. As the length of the loop of cable 32 is decreased, tension is applied between pulley 42 (attached to portion 28 at the left end of headband 26) and knob 44 (attached to portion 28 at the right end of headband 26).

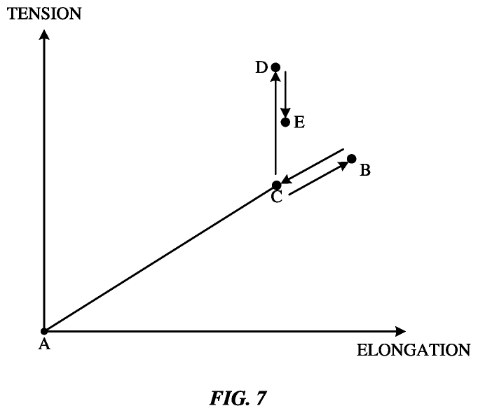

FIG. 7 is a graph illustrating a user's experience with adjusting headband 26 in these different modes. In the graph of FIG. 7, headband tension has been plotted as a function of headband elongation. States A, B, C, D, and E correspond to different stages of the process of donning device 10.

Initially, at state A, device 10, including housing 12 (and its members 24) and headband 26, may be resting on a table or other surface. Because device 10 is not being worn, there is no outward force being exerted on headband 26. Accordingly, cable 32 may retract to its smallest length (e.g., a retraction spring associated with knob 44 retracts cable 32) and the stretchable fabric of portion 30 may contract to its minimum length.

When a user desires to don device 10, the user picks up device 10 from its resting location, places the rear of housing 12 against front surface 20F of the user's head (e.g., so that optical modules in housing 12 are aligned with the user's eyes), and lengthens headband 26 by pulling outwardly (e.g., rearwardly) on headband 26 (e.g., device 10 transitions from state A to state B). When pulled outwardly, knob 44 spools out cable 32 freely keeping it taught, while stretchable portion 30 of headband 26 stretches to help lengthen headband 26.

After the user positions headband 26 adjacent to rear head surface 20R and lets go of headband 26, portion 30 retracts. The tension provided by the stretchy knit fabric of portion 30 provides sufficient tension to help hold device 10 in place (state C). In this situation, cable 32 remains taught while the tensioning spring in knob 44 reels in excess cable as the knit fabric of portion 30 recovers from stretching and shortens.

Once device 10 has tentatively been mounted on the user's head in this way, the user may use the cable tensioning mechanism of headband 26 to adjust the tension of cable 32 and thereby select the final desired tension for headband 26. For example, the user may rotate knob 44 in direction 48 (FIG. 2) to increase tension in headband 26 (see, e.g., state D) and may rotate knob 44 in direction 50 (FIG. 2) to decrease tension in headband 26. Such tension adjustments may continue until a desired amount of tension has been achieved (e.g., a tension level sufficiently high to provide a desired stability level for device 10 while being sufficiently low to provide a desired comfort level). When it is desired to doff device 10, tension may be released from headband 26 by rotating knob 44 in direction 50, by activation of a release mechanism (e.g., a releasable catch in knob 44), and/or by pulling headband 26 outward with sufficient force to overcome the retention force applied by knob 44 and thereby cause knob 44 to spool out cable 32 (e.g., in configurations in which headband 26 has an auto-spooling spring mechanism). Device 10 can then be placed in a storage location (state A) awaiting subsequent use.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

In accordance with an embodiment, an adjustable-tension headband operable with a head-mounted device housing having displays configured to display images to eye boxes, the adjustable-tension headband is provided that includes a stretchable portion that is configured to create headband tension when stretched, and an adjustable-tension cable configured to create headband tension.

In accordance with another embodiment, the stretchable portion includes stretchable fabric and stretchable fabric and the adjustable-tension cable are operable in a stretch fabric tensioned mode in which headband tension is provided by stretching the stretchable fabric while the adjustable-tension cable does not provide headband tension, and a cable-tensioned mode in which headband tension is provided by tensioning the adjustable-tension cable.

In accordance with another embodiment, the adjustable-tension headband includes first and second non-stretchable end portions configured to couple, respectively, to first and second sides of the head-mounted housing, the stretchable portion extends between the first and second non-stretchable portions.

In accordance with another embodiment, the stretchable fabric includes knit fabric.

In accordance with another embodiment, the knit fabric has a channel configured to receive the adjustable-tension cable.

In accordance with another embodiment, the adjustable-tension headband includes a pulley that is attached to the first non-stretchable end portion and that receives the adjustable-tension cable.

In accordance with another embodiment, the pulley includes a tube that receives the cable and the cable includes a multifilament core surrounded by a braided sheath.

In accordance with another embodiment, the adjustable-tension headband includes an adjustable cable tensioning mechanism coupled to the adjustable-tension cable.

In accordance with another embodiment, the adjustable cable tensioning mechanism includes a rotatable knob that is configured to adjust tension in the adjustable-tension cable.

In accordance with another embodiment, the stretchable portion includes a channel that receives the adjustable-tension cable.

In accordance with another embodiment, the adjustable-tension cable forms a loop having a loop length and the adjustable-tension headband includes a cable tensioning mechanism coupled to the adjustable-tension cable that is configured to adjust the loop length.

In accordance with another embodiment, the adjustable-tension headband includes a pulley, the loop extends between the cable tensioning mechanism and the pulley.

In accordance with another embodiment, the stretchable portion includes fabric.

In accordance with another embodiment, the adjustable-tension headband includes fabric with a pocket, and a stiffener in the pocket.

In accordance with another embodiment, the adjustable-tension headband includes an opening in the fabric that is aligned with a corresponding opening in the stiffener.

In accordance with another embodiment, the stiffener includes a flexible polymer strip.

In accordance with another embodiment, the stretchable portion has an upper edge and a lower edge, a first segment of the adjustable-tension cable runs along the upper edge and a second segment of the adjustable-tension cable runs along the lower edge.

In accordance with another embodiment, the first and second segments are separated by at least 2 cm.

In accordance with an embodiment, a head-mounted device headband operable with a head-mounted device housing containing a display is provided that includes a first end portion configured to couple to a first side of a head-mounted device housing, a second end portion configured to couple to an opposing second side of the head-mounted device housing, a stretchable fabric portion extending between the first and second end portions, a cable extending between the first and second end portions, and a cable tensioning mechanism configured to adjust tension in the cable.

In accordance with an embodiment, a head-mounted device support configured to couple to a head-mounted device housing, the head-mounted device support is provided that includes first and second non-stretchable portions, a stretchable portion between the first and second non-stretchable portions that is configured to pull the first and second non-stretchable portions together when stretched, a loop of cable that is received within a channel in the stretchable portion, and an adjustable cable tensioning mechanism that is configured to adjust the loop of cable to pull the first and second non-stretchable portions together with an adjustable amount of cable tension in addition to pulling the first and second non-stretchable portions together with the stretchable portion when stretched.

In accordance with another embodiment, the stretchable portion has a first longitudinal stiffness, the cable in the loop of cable has a second longitudinal stiffness, and the second longitudinal stiffness is greater than the first longitudinal stiffness.

The foregoing is merely illustrative and various modifications can be made to the described embodiments. The foregoing embodiments may be implemented individually or in any combination.

What is claimed is:

1. An adjustable-tension headband operable with a head-mounted device housing having displays configured to display images to eye boxes, the adjustable-tension headband comprising
a stretchable portion that is configured to create headband tension when stretched; and
an adjustable-tension cable configured to create headband tension.

2. The adjustable-tension headband defined in claim 1 wherein the stretchable portion comprises stretchable fabric and wherein stretchable fabric and the adjustable-tension cable are operable in:
a stretch fabric tensioned mode in which headband tension is provided by stretching the stretchable fabric while the adjustable-tension cable does not provide headband tension; and
a cable-tensioned mode in which headband tension is provided by tensioning the adjustable-tension cable.

3. The adjustable-tension headband defined in claim 1 further comprising first and second non-stretchable end portions configured to couple, respectively, to first and second sides of the head-mounted housing, wherein the stretchable portion extends between the first and second non-stretchable portions.

4. The adjustable-tension headband defined in claim 3 wherein the stretchable fabric comprises knit fabric.

5. The adjustable-tension headband defined in claim 4 wherein the knit fabric has a channel configured to receive the adjustable-tension cable.

6. The adjustable-tension headband defined in claim 5 further comprising a pulley that is attached to the first non-stretchable end portion and that receives the adjustable-tension cable.

7. The adjustable-tension headband defined in claim 6 wherein the pulley comprises a tube that receives the cable and wherein the cable comprises a multifilament core surrounded by a braided sheath.

8. The adjustable-tension headband defined in claim 1 further comprising an adjustable cable tensioning mechanism coupled to the adjustable-tension cable.

9. The adjustable-tension headband defined in claim 8 wherein the adjustable cable tensioning mechanism comprises a rotatable knob that is configured to adjust tension in the adjustable-tension cable.

10. The adjustable-tension headband defined in claim 1 wherein the stretchable portion comprises a channel that receives the adjustable-tension cable.

11. The adjustable-tension headband defined in claim 10 wherein the adjustable-tension cable forms a loop having a loop length and wherein the adjustable-tension headband further comprises a cable tensioning mechanism coupled to the adjustable-tension cable that is configured to adjust the loop length.

12. The adjustable-tension headband defined in claim 11 further comprising a pulley, wherein the loop extends between the cable tensioning mechanism and the pulley.

13. The adjustable-tension headband defined in claim 1 wherein the stretchable portion comprises fabric.

14. The adjustable-tension headband defined in claim 1 further comprising:
fabric with a pocket; and
a stiffener in the pocket.

15. The adjustable-tension headband defined in claim 14 further comprising an opening in the fabric that is aligned with a corresponding opening in the stiffener.

16. The adjustable-tension headband defined in claim 14 wherein the stiffener comprises a flexible polymer strip.

17. The adjustable-tension headband defined in claim 1 wherein the stretchable portion has an upper edge and a lower edge, wherein a first segment of the adjustable-tension cable runs along the upper edge and wherein a second segment of the adjustable-tension cable runs along the lower edge.

18. The adjustable-tension headband defined in claim 17 wherein the first and second segments are separated by at least 2 cm.

19. A head-mounted device headband operable with a head-mounted device housing containing a display, comprising:
a first end portion configured to couple to a first side of a head-mounted device housing;
a second end portion configured to couple to an opposing second side of the head-mounted device housing;
a stretchable fabric portion extending between the first and second end portions;
a cable extending between the first and second end portions; and
a cable tensioning mechanism configured to adjust tension in the cable.

20. A head-mounted device support configured to couple to a head-mounted device housing, the head-mounted device support comprising:
first and second non-stretchable portions;
a stretchable portion between the first and second non-stretchable portions that is configured to pull the first and second non-stretchable portions together when stretched;
a loop of cable that is received within a channel in the stretchable portion; and
an adjustable cable tensioning mechanism that is configured to adjust the loop of cable to pull the first and second non-stretchable portions together with an adjustable amount of cable tension in addition to pulling the first and second non-stretchable portions together with the stretchable portion when stretched.

21. The head-mounted device defined in claim 20 wherein the stretchable portion has a first longitudinal stiffness, wherein the cable in the loop of cable has a second longitudinal stiffness, and wherein the second longitudinal stiffness is greater than the first longitudinal stiffness.
